(19) United States
(12) Patent Application Publication
(10) Pub. No.: US 2013/0142373 A1
(43) Pub. Date: Jun. 6, 2013

(54) ARRAY SPEAKER SYSTEM

(71) Applicant: TEI CO., LTD., Tokyo (JP)

(72) Inventor: HITOSHI KANAYA, YOKOHAMA-SHI (JP)

(73) Assignee: TEI CO., LTD., TOKYO (JP)

(21) Appl. No.: 13/645,270

(22) Filed: Oct. 4, 2012

(30) Foreign Application Priority Data
Oct. 6, 2011 (JP) 2011-221551
Sep. 27, 2012 (JP) 2012-214921

(51) Int. Cl. H04R 1/02

(52) U.S. Cl. CPC H04R 1/025
USPC 381/354; 381/162

(57) ABSTRACT

An array speaker system includes a plurality of speaker units that respectively emit sounds in accordance with an input signal and an outer casing that supports the plurality of speaker units. Each speaker unit can be provided with a speaker operable to vibrate a vibrator in accordance with the signal, and a cavity back box that supports the speaker. The cavity back box forms a rear space with the vibrator on the opposite side with respect to the sound emission surface. The array speaker system thus constructed can emit a high power sound with a simple structure and improved stability in acoustic properties.

This application claims the benefit of priority from Japanese Patent Application No. 2011-221551, filed on 6 Oct. 2011 and Japanese Patent Application No. 2012-214921, filed on 27 Sep. 2012, the contents of which are incorporated herein by reference.

### BACKGROUND

1. Technical Field

The present disclosure relates to an array speaker system.

2. Description of the Related Art

As one type of speaker system, there is provided an array speaker system having a plurality of speakers arrayed in one line or a plurality of lines. The array speaker system includes a plurality of sound emission surfaces arrayed in one line or a plurality of lines. The array speaker system may be composed of a plurality of speakers arrayed in one line or a plurality of lines and an outer casing that supports the plurality of speakers (see patent documents 1 to 5).

The speaker may include a conical type diaphragm or a flat type diaphragm.

As one type of speaker that constitutes the array speaker system, a speaker having a conical type diaphragm can be used.

The speaker having a conical type diaphragm emits a sound from a conical shaped emission surface. For example, the speaker may be composed of a conical shaped diaphragm, a frame, and a voice coil type actuator. The diaphragm is deformable in the out-of-plane direction.

The voice coil type actuator is adapted to vibrate a diaphragm in the out-of-plane direction and emit a sound from a surface of the diaphragm when an alternating voltage is applied to a voice coil positioned within a magnetic gap.

FIG. 14 is a front view of a prior art array speaker system having a plurality of circular speakers arrayed one after another. The array speaker system 30 is composed of a plurality of speaker units 300, each including a circular diaphragm 311 and a frame 313.

In the prior art array speaker system 30, sounds emitted from the circular diaphragms 311 of respective speaker units 300 overlap with one another. Consequently, the prior art array speaker system 30 can obtain a high acoustic output in comparison with a case in which the speaker unit 300 is used alone.

As another type of speaker that constitutes the array speaker system, a speaker having a flat type diaphragm can be used.

The speaker having a flat type diaphragm emits a sound from a flat emission surface.

For example, the speaker may be composed of a diaphragm made of a flat plate, an edge, a frame, and a voice coil type actuator. The frame supports the diaphragm via the edge.

The voice coil type actuator is adapted to vibrate a diaphragm in the out-of-plane direction and emit a sound from a surface of the diaphragm when an alternating voltage is applied to a voice coil positioned within a magnetic gap.

### PATENT DOCUMENTS

Patent Document 1: Japanese Unexamined Patent Application, Publication No. H11-225389

### Patent Document 2: Japanese Unexamined Patent Application, Publication No. 2005-210508

Patent Document 1: Japanese Unexamined Patent Application, Publication No. H06-233377
Patent Document 1: Japanese Unexamined Patent Application, Publication No. H05-91586
Patent Document 1: Japanese Unexamined Patent Application, Publication No. H06-90494

### SUMMARY

The array speaker system can obtain a high acoustic output in comparison with a case in which only one speaker unit is used since the sound is emitted from a plurality of speakers arrayed in one line. However, in the prior art array speaker system, an outer casing that supports the plurality of speakers forms a large rear space in which sounds generated from the plurality of speakers reverberate, thereby generating low frequency standing waves that are difficult to attenuate. These low frequency standing waves may exert unexpected influence on acoustic properties of the array speaker system.

Furthermore, as shown in FIG. 14, in the prior art array speaker system having a plurality of circular speakers arrayed one after another, a sound emission surface G′ formed by the circular diaphragm 311 is in the form of a circular shape. Consequently, the distance between adjacent sound emission surfaces varies as designated by distances d1, d2, and d3. Accordingly, various interferences may be caused to occur at different frequencies in accordance with differences in distances between the adjacent sound emission surfaces.

To minimize the influences caused by such acoustic interferences, it is desirable to make the distance between the adjacent sound emission surfaces as small as possible. However, in a case of the speaker having circular sound emission surfaces, a drawback is encountered in which there is a limitation of reducing the distance between the adjacent sound emission surfaces and, in addition, the speaker tends to become complicated in structure.

In view of the above described problems, some embodiments provide an array speaker system that can emit a high power sound with a simple structure and improved stability in acoustic properties.

In order to achieve the above described objects, in accordance with one aspect of the present invention, there is provided an array speaker system including a plurality of speaker units that respectively emit sounds in accordance with an input signal and an outer casing that supports the plurality of speaker units. Each speaker unit is provided with a speaker operable to vibrate a vibrator in accordance with the signal, and a cavity back box that supports the speaker. The cavity back box forms a rear space with the vibrator on the opposite side with respect to the sound emission surface.

Since the plurality of speaker units are arrayed with one another, it becomes possible to output a high power sound with a simple structure. Furthermore, in each of the speaker units, a rear space is formed by the cavity back box on the opposite side with respect to the sound emission surface. As a result thereof, since the size of the rear space is limited to dimensions determined in accordance with the size of the speaker unit, it becomes possible to make the frequencies of the standing waves relatively high. Since it is easy to attenuate high frequency standing waves, it is possible to stabilize acoustic properties. Accordingly, it is possible to provide an array speaker system that can emit a high power sound with a simple structure and have stable acoustic properties.

In the aforementioned array speaker system, the cavity back boxes of the respective speaker units may be identical in shape and size to one another. According to such configuration, it is possible to make standing waves generated in the rear spaces of respective speaker units similar to one another in vibration properties. As a result thereof, it is possible to make speaker units similar to one another in acoustic properties.

Furthermore, in the aforementioned array speaker system, the outer casing may support the plurality of speaker units arrayed equidistantly in one line. According to such configuration, it is possible to make the acoustic property of the synthetic sound of the sounds respectively emitted from the speaker units, as a whole, uniform with respect to the direction, in which speaker units are arrayed.

Furthermore, in the aforementioned array speaker system, a cross section area (or cross section area of a part) of the rear space cut along a plane perpendicular to a direction, in which the plurality of speaker units are arrayed, may be constant, viewed at equal intervals from the direction, in which the plurality of speaker units are arrayed. According to such configuration, it is possible to stabilize the properties of the standing waves generated in the rear spaces, and to reduce the disturbance in the acoustic property of the synthetic sound of the sounds respectively emitted from the speaker units along the direction in which the speaker units are arrayed.

Furthermore, in the aforementioned array speaker system, the sound emission surface of the vibrator of each of the speaker units constituting the array speaker system may have a contour including a pair of long sides extending in parallel relationship to each other with respect to the direction, in which the plurality of speaker units are arrayed, and a pair of short sides extending in parallel relation to each other. According to such configuration, it is possible to reduce the disturbance in the acoustic property of the synthetic sound of the sounds respectively emitted from the speaker units, with respect to the direction in which the speaker units are arrayed.

Furthermore, in the aforementioned array speaker system, each of the speaker units may have the rear space filled with a sound absorber. According to such configuration, it is possible to attenuate the standing wave generated in the rear space.

Furthermore, in the aforementioned array speaker system, the sound emission surface may be in the form of a flat shape extending along a plane parallel to the direction, in which the plurality of speaker units are arrayed. According to such configuration, it is possible to stabilize the standing waves generated in the rear space and to reduce their influences exerted on the sound emission surface. Furthermore, it is possible to stabilize the acoustic property of the array speaker system so as to have a directivity pattern of a fan shape represented in a sound pressure level distribution curve.

Furthermore, in the aforementioned array speaker system, the rear space may be substantially sealed. According to such configuration, the standing wave generated in the rear space can hardly be affected from any space exterior to the rear space. As a result thereof, it is possible to stabilize the standing wave.

Furthermore, in the aforementioned array speaker system, the sound absorber may include a plurality of sound absorbents disposed adjacent to one another in a multilayered manner, wherein the plurality of sound absorbents are different from one another in sound absorption property. According to such configuration, it is possible to attenuate standing waves of various frequencies by means of the plurality of sound absorbents different from one another in sound absorption property. Accordingly, it is possible to attenuate the standing waves generated in the rear space in a more stable manner.

Furthermore, in the aforementioned array speaker system, the cavity back box may include a first cavity back box that supports the speaker and a second cavity back box that supports the first cavity back box. The rear space includes a first rear space formed by the first cavity back box on the opposite side with respect to the sound emission surface of the vibrator and a second rear space formed by the second cavity back box, wherein the first rear space is held in communication with the first rear space. The first rear space may be less in volume than the second rear space. According to such configuration, it is possible to reduce the influence of the standing wave generated in the second rear space on the vibrator via the first rear space.

Furthermore, in the aforementioned array speaker system, each speaker unit may be formed with a cutout portion partially cut away in front of the sound emission surface. According to such configuration, owing to the cutout portion disposed in front of the sound emission surface, sound waves emitted from the sound emission surface are emitted toward the front side of the speaker unit without being disturbed by the cavity back box, thereby making it possible to realize a directivity having little disturbance.

According to some embodiments of the present invention, it is possible to provide an array speaker system having a high power output and stable acoustic properties with a simple structure.

### BRIEF DESCRIPTION OF THE DRAWINGS

Systems and methods that embody the various features of the invention will now be described with reference to the following drawings, in which:

FIG. 1 is a perspective view of an array speaker system according to a first embodiment of the present invention;

FIG. 2 is a perspective view of an array speaker system according to a second embodiment of the present invention;

FIG. 3 is a perspective view of an array speaker system according to a third embodiment of the present invention;

FIG. 4 is a cross-sectional view cut along a line A-A of the speaker according to the third embodiment of the present invention;

FIG. 5 is a side view of the speaker according to the third embodiment of the present invention;

FIG. 6 is a front view of a speaker according to the third embodiment of the present invention;

FIG. 7 is a side sectional view of the array speaker system according to the third embodiment of the present invention;

FIG. 8 is a plane cross section view of the array speaker system according to the third embodiment of the present invention;

FIG. 9 is a plane cross section view of an array speaker system according to a fourth embodiment of the present invention;

FIG. 10 is a plane cross section view of an array speaker system according to a fifth embodiment of the present invention;

FIG. 11 is a diagram illustrating an action of the array speaker system according to the embodiments of the present invention;

FIG. 12 is a diagram illustrating an acoustic property of the array speaker system according to the embodiments of the present invention;

FIG. 13 is a front view of the array speaker system according to the embodiments of the present invention; and

FIG. 14 is a front view of a prior art array speaker system having a plurality of circular speakers in a line.

### DETAILED DESCRIPTION

In the following, a description will be given of certain embodiments of the present invention with reference to drawings. In all described embodiments, similar constituent elements are denoted by the same symbols.

While certain embodiments are described, these embodiments are presented by way of example only, and are not intended to limit the scope of protection. Indeed, the novel methods and systems described herein may be embodied in a variety of other forms. Furthermore, various omissions, substitutions, and changes in the form of the methods and systems described herein may be made without departing from the scope of protection.

The following description is directed to an array speaker system 10 according to a first embodiment of the present invention with reference to drawings.

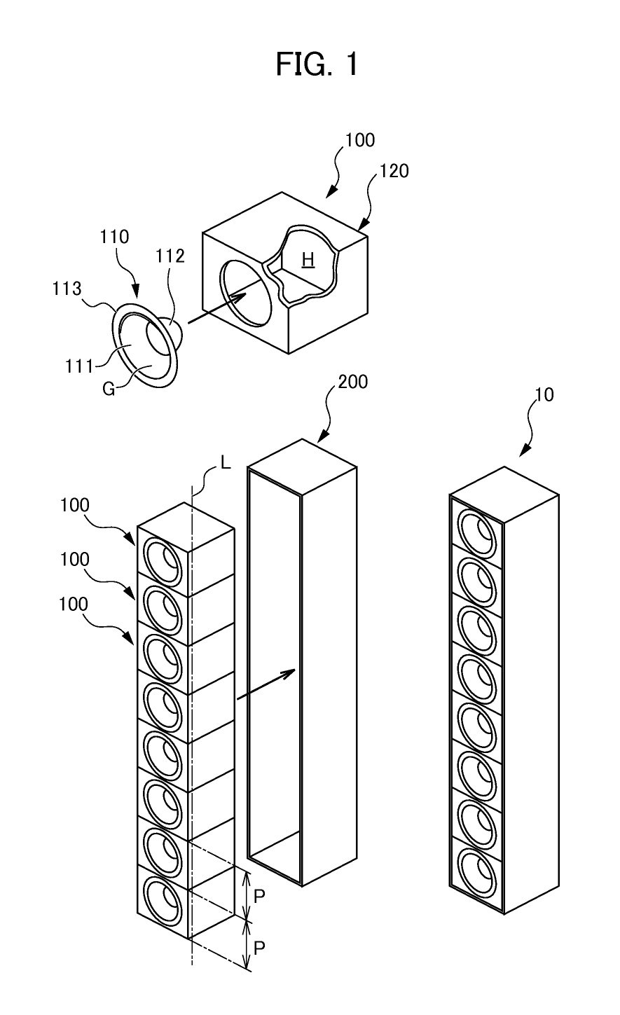

FIG. 1 is a perspective view of the array speaker system 10 according to the first embodiment of the present invention, including a partially cutaway perspective view of a speaker unit 100, shown as being partially cut away, and perspective views showing an outer casing 200 supporting a plurality of speaker units 100. A rear space H of the speaker unit 100 is shown in the partially cutaway perspective view of the speaker unit 100.

The array speaker system 10 includes the plurality of speaker units 100 and the outer casing 200.

Each of the speaker units 100 is constituted by, for example, an acoustic device that emits a sound in accordance with a signal inputted to the speaker unit 100.

The outer casing 200 is constituted by a structure that supports the plurality of speaker units 100 arrayed in one line.

As shown in the partially cutaway perspective view of FIG. 1, each speaker unit 100 constituting the array speaker system 10 includes a speaker 110 and a cavity back box 120.

Each speaker unit 100 constituting the array speaker system 10 may include the speaker 110, the cavity back box 120, and a sound absorber (not shown in FIG. 1).

The speaker 110 includes a vibrator 111 and an actuator 112.

The speaker 110 may include the vibrator 111, the actuator 112, and an actuator frame 113.

The speaker 110 is constituted by, for example, a dynamic speaker.

A sound emission surface G that emits sounds is provided on a front surface of the vibrator 111.

For example, a conical shaped sound emission surface G may be provided on a front surface of the vibrator 111.

The vibrator 111 may be constituted by, for example, a conical type diaphragm.

The actuator 112 drives the vibrator 111 in accordance with a signal. The actuator 112 may be constituted by, for example, a voice coil type actuator.

The cavity back box 120 supports the speaker 110 and forms a rear space H enclosed with the cavity back box 120 and the speaker 110 on the rear side of the vibrator 111, which is opposite to the side provided with the sound emission surface G.

The cavity back boxes 120 of the respective speaker units 100 may be identical in shape and size to one another as shown in FIG. 1. More particularly, the speakers 110 constituting the respective speaker units 100 may be identical in shape and size and installation position in the cavity back box 120 to one another so that the rear spaces H of the respective speaker units 100 may be identical in shape and size to one another.

As shown in FIG. 1, the outer casing 200 may support the plurality of speaker units 100 in a state that the speaker units 100 are arrayed in one line at the same intervals of a pitch P. The sheet thickness of the outer casing 200 is greater than, for example, the sheet thickness of the cavity back box 120. Since the speaker 110 is supported not only by the cavity back box 120 but also by the outer casing 200 which is thicker in the sheet thickness than the cavity back box 120, the resonance frequency of the speaker unit 100 is made high in comparison to a case in which the speaker 110 is supported by the cavity back box 120 alone. Accordingly, standing waves generated in the rear space H can be made high (the sound waves of high frequencies can be easily attenuated in comparison with the sound waves of low frequencies, which will be described later). Also, the same effect can be expected if the outer casing 200 is higher in rigidity than the cavity back box 120.

Here, the pitch P is intended to mean a length of each speaker unit 100 in a direction (direction in which an imaginary line L, described later, is extended), in which the speaker units 100 are arrayed.

For example, assuming an imaginary line L, in FIG. 1, the plurality of speaker units 100 are arrayed in one line along the imaginary line L, and the outer casing 200 supports the plurality of speaker units 100 arrayed in one line along the imaginary line L. Furthermore, the plurality of speaker units 100 may be arrayed in one line along the imaginary line L equidistantly, for example, at the same intervals of the pitch P, and the outer casing 200 may support the plurality of speaker units 100 arrayed along the imaginary line L equidistantly, for example, at the same intervals of the pitch P. Also, the plurality of speaker units 100 may be arrayed respectively in a plurality of lines arranged one line after another, and the outer casing 200 may support the plurality of speaker units 100 respectively arrayed in the plurality of lines arranged one line after another along the imaginary line L. The imaginary line L indicates a direction in which the plurality of the speaker units 100 is arrayed, and may be a straight line, or may be a curved line. Here, the sound emission surfaces G of the respective speaker units 100 are facing toward the same direction perpendicular to the imaginary line L.

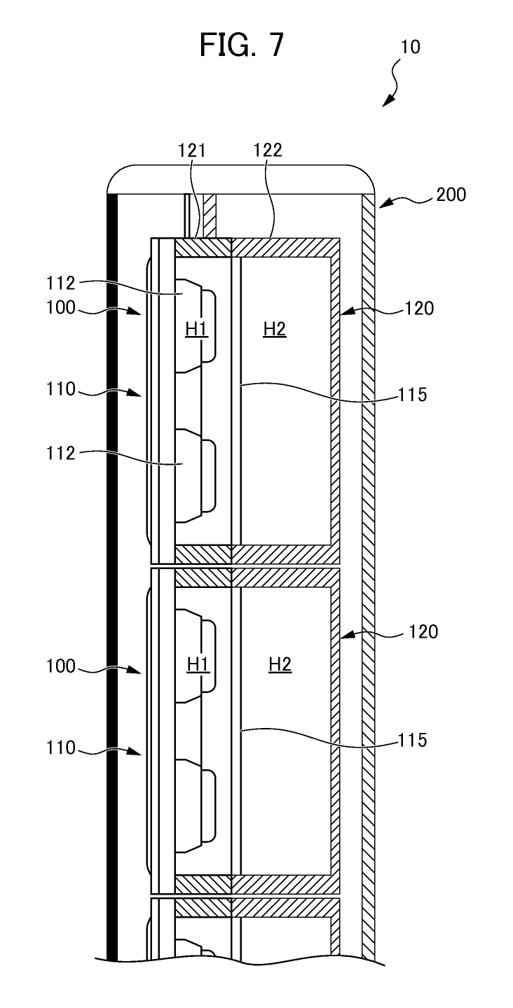

The shape of the rear space H may be made such that the cross section area of the rear space H cut along any plane perpendicular to the imaginary line L may be always constant along the imaginary line L. Also, the shape and size of the contour of the cross section of the rear space H cut along any plane perpendicular to the imaginary line L may be always constant along the imaginary line L. In any case, the side surface and the rear surface of the rear space H are installed in parallel to the imaginary line L. Also, the shape of the front surface of the rear space H (installation surface of the speaker) is configured to be parallel to the imaginary line L. Alternatively, in a case in which the shape of the front surface of the rear space H (installation surface of the speaker) is not parallel to the imaginary line L (for example, in a case in which the shape of the rear surface of the actuator is complex), the rear space H may be made such that the rear space H is partitioned into a plurality of spaces along the imaginary line L, and a cross section area of the partitioned space (area of a cross section of the partitioned space cut along an imaginary plane perpendicular to the imaginary line L) is constant along the imaginary line L, as shown in FIG. 7, which will be described later.

Standing waves are generated at frequencies in accordance with the size of the rear space H formed by the speaker 110 and the cavity back box 120 on the rear side thereof. More particularly, standing waves are generated with half wavelengths of a distance between top and bottom sides of the rear space H, a distance between left and right sides of the rear space H, and a distance between front and rear sides of the rear space H, wherein the front side of the rear space H is an installation surface of the speaker. Since one wavelength of a sound is acquired by dividing the propagation speed of the sound (≈34000 cm/s) by frequency, the half wavelength of a 1700 Hz frequency sound is approximately 10 cm. This means that if the largest dimension of the cavity back box 120, for example, a distance between top and bottom of the cavity back box 120 is designed to be 10 cm, standing waves having frequencies lower than 1700 Hz will not be generated.

Since the cross section area of the rear space H cut along any imaginary plane perpendicular to the imaginary line L is always constant along the imaginary line L, it is possible to maintain the wavelengths of the generated standing waves approximately constant.

Furthermore, since the contour, shape and size of the cross section of the rear space H (or cross section of a part of the rear space H) cut along any imaginary plane perpendicular to the imaginary line L is always constant along the imaginary line L, it is possible to maintain the wavelengths of the generated standing waves approximately constant along the imaginary line L.

Furthermore, the rear space H may be substantially sealed except for a small gap caused during the assembling process.

The sound absorber is constituted by material operable to attenuate the standing waves generated in the rear space H, and the rear space H may be filled with the sound absorber.

This means that each speaker unit 100 of the array speaker system 10 may have the sound absorber, which the rear space H is to be filled with.

The sound absorber may be made by a plurality of sound absorbents disposed adjacent to one another in a multilayered manner, wherein the plurality of sound absorbents are different from one another in sound absorption property.

In this case, it is preferable that boundary lines of a plurality of sound absorbents disposed in a multilayered manner are parallel with respect to the sound emission surface. Especially, it is preferable to employ such multilayered sound absorbents if a shape of the front surface of the rear space H (installation surface of the speaker) is not parallel with respect to the imaginary line L (for example, in a case in which the shape of the rear surface of the actuator is complex).

The sound absorbents may be made of material which can effectively absorb standing waves generated in the rear space H, and may include, for example, glass wool, a resin plate, or the like.

Although, it has been described as an example that the outer casing 200 shown in FIG. 1 is constituted by a structure to accommodate and support the plurality of speaker units 100 arrayed in one line, the present disclosure is not limited thereto. For example, similar effects can be expected even if the outer casing is constituted by a structure that accommodates and supports a plurality of speaker units 100 arrayed in a plurality of lines arranged one line after another along the imaginary line L.

The following description is directed to an array speaker system 10 according to a second embodiment of the present invention with reference to drawings.

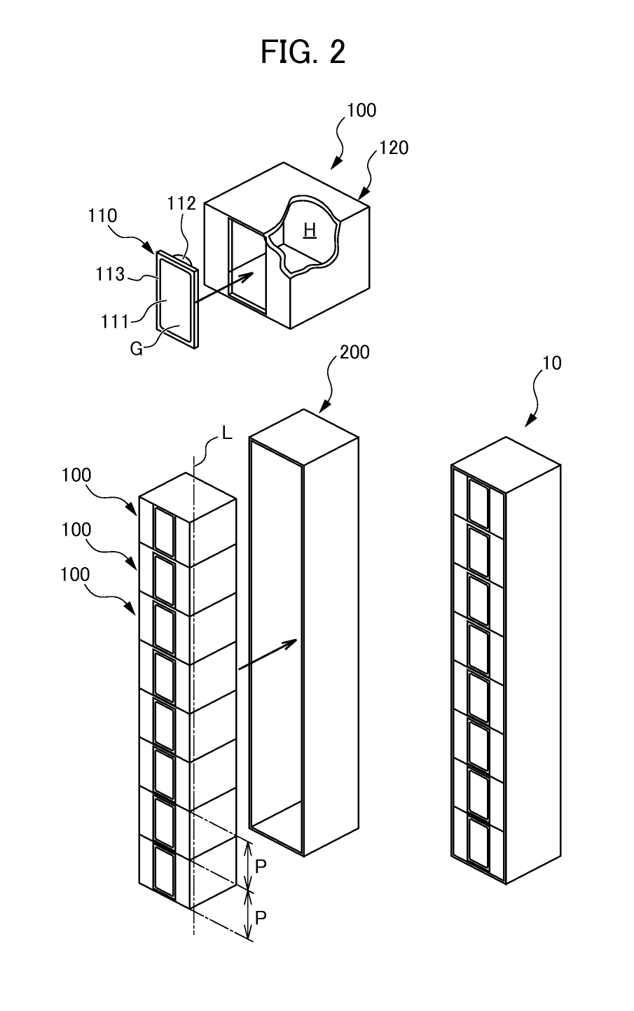

FIG. 2 is a perspective view of the array speaker system 10 according to the second embodiment of the present invention, including a partially cutaway perspective view of a speaker unit 100, shown as being partially cut away, and a perspective view showing an outer casing 200 supporting a plurality of speaker units 100. A rear space H of the speaker unit 100 is shown in the partially cutaway perspective view of the speaker unit 100. Constituent elements corresponding to the array speaker system 10 according to the first embodiment of the present invention are denoted by the same symbols, and description thereof is partially omitted.

The array speaker system 10 includes the plurality of speaker units 100 and the outer casing 200.

The speaker unit 100 is an acoustic device that emits a sound in accordance with a signal inputted to the speaker unit 100.

The outer casing 200 is constituted by a structure that supports the plurality of speaker units 100 arrayed in one line.

As shown in the partially cutaway perspective view of FIG. 2, each speaker unit 100 constituting the array speaker system 10 includes a speaker 110 and a cavity back box 120.

Each speaker unit 100 constituting the array speaker system 10 may include the speaker 110, the cavity back box 120, and a sound absorber (not shown in FIG. 2).

The speaker 110 includes a vibrator 111 and an actuator 112.

The speaker 110 may include the vibrator 111, the actuator 112, and an actuator frame 113.

For example, the speaker 110 is constituted by a flat speaker.

A sound emission surface G that emits sounds is provided on a front surface of the vibrator 111. For example, the vibrator 111 is constituted by a flat type diaphragm.

In the present embodiment, the vibrator 111 is provided with the sound emission surface G in the form of a flat shape extending along a plane parallel to the imaginary line L, which has been described in the previous embodiment.

The sound emission surface G of the vibrator 111 is in the form of a rectangular shape, and constituted by, for example, a contour including a pair of long sides parallel to each other and a pair of short sides parallel to each other, as shown in FIG. 2.

An edge part of the vibrator 111 is supported by the actuator frame 113 so as to be capable of vibrating in a direction perpendicular to a vibrating surface.

The sound emission surfaces G of the respective speaker units 100 may be arranged in such a manner that the long sides of the sound emission surfaces G are respectively parallel with respect to the imaginary line L.

The actuator 112 drives the vibrator 111 in accordance with a signal inputted in the speaker unit 100.

The actuator 112 may be constituted by, for example, a voice coil type actuator.

In the array speaker system 10, it is preferable that the sound emission surfaces G of the respective vibrators 111 face toward the same direction. However, as appropriate, any modification may be made to the sound emission surfaces G, in accordance with required acoustic property.

The cavity back box 120 supports the speaker 110 and forms a rear space H enclosed with the cavity back box 120 and the speaker 110 on the rear side of the vibrator 111, which is opposite to the side provided with the sound emission surface G.

The cavity back boxes 120 of the respective speaker units 100 may be identical in shape and size to one another as shown in FIG. 2. More particularly, the speakers 110 constituting the respective speaker units 100 may be identical in shape and size and installation position in the cavity back box 120 to one another so that the rear spaces H of the respective speaker units 100 may be identical in shape and size to one another.

The sheet thickness of the outer casing 200 is greater than, for example, the sheet thickness of the cavity back box 120. Since the speaker 110 is supported not only by the cavity back box 120 but also by the outer casing 200 which is thicker in the sheet thickness than the cavity back box 120, the resonance frequency of the speaker unit 100 is made high in comparison to a case in which the speaker 110 is supported by the cavity back box 120 alone. Accordingly, standing waves generated in the rear space H can be made high (the sound waves of high frequencies can be easily attenuated in comparison with the sound waves of low frequencies, which will be described later). Also, the same effect can be expected if the outer casing 200 is higher in rigidity than the cavity back box 120.

As shown in FIG. 2, the outer casing 200 supports the plurality of speaker units 100 in a state that the speaker units 100 are arrayed in one line at the same intervals of the pitch P.

For example, assuming an imaginary line L, the plurality of speaker units 100 are arrayed in one line along the imaginary line L, and the outer casing 200 supports the plurality of speaker units 100 arrayed in one line along the imaginary line L. Furthermore, the plurality of speaker units 100 may be arrayed in one line along the imaginary line L equidistantly, for example, at the same intervals of the pitch P, and the outer casing 200 may support the plurality of speaker units 100 arrayed along the imaginary line L equidistantly, for example, at the same intervals of the pitch P. Also, the plurality of speaker units 100 may be arrayed respectively in a plurality of lines arranged one line after another, and the outer casing 200 may support the plurality of speaker units 100 respectively arrayed in the plurality of lines arranged one line after another along the imaginary line L. The imaginary line L indicates a direction in which the plurality of the speaker units 100 is arrayed, and may be a straight line, or may be a curved line. Here, the sound emission surfaces G of the respective speaker units 100 are facing toward the same direction perpendicular to the imaginary line L.

The shape of the rear space H may be made such that the cross section area of the rear space H cut along any plane perpendicular to the imaginary line L may be always constant along the imaginary line L. Also, the shape and size of the contour of the cross section of the rear space H cut along any plane perpendicular to the imaginary line L may be always constant along the imaginary line L. In any case, the side surface and the rear surface of the rear space H are installed in parallel to the imaginary line L. Also, the shape of the front surface of the rear space H (installation surface of the speaker) is configured to be parallel to the imaginary line L.

Alternatively, in a case in which the shape of the front surface of the rear space H (installation surface of the speaker) is not parallel to the imaginary line L (for example, in a case in which the shape of the rear surface of the actuator is complex), the rear space H may be made such that the rear space H is partitioned into a plurality of spaces along the imaginary line L, and a cross section area of the partitioned space (area of a cross section of the partitioned space cut along an imaginary plane perpendicular to the imaginary line L) is constant along the imaginary line L, as shown in FIG. 7, described later.

Standing waves are generated at frequencies in accordance with the size of the rear space H formed by the speaker 110 and the cavity back box 120 on the rear side thereof. More particularly, standing waves are generated with half wavelengths of a distance between top and bottom sides of the rear space H, a distance between left and right sides of the rear space H, and a distance between front and rear sides of the rear space H, wherein the front side of the rear space H is an installation surface of the speaker. Since one wavelength of a sound is acquired by dividing the propagation speed of the sound (≈34000 cm/s) by frequency, the half wavelength of a 1700 Hz frequency sound is approximately 10 cm. This means that if the largest dimension of the cavity back box 120, for example, a distance between top and bottom of the cavity back box 120 is designed to be 10 cm, standing waves having frequencies lower than 1700 Hz will not be generated.

Since the cross section area of the rear space H cut along the imaginary plane perpendicular to the imaginary line L is constant along the imaginary line L, it is possible to maintain the wavelengths of the generated standing waves approximately constant.

Furthermore, since the contour, shape and size of the cross section of the rear space H (or cross section of a part of the rear space H) cut along any imaginary plane perpendicular to the imaginary line L is always constant along the imaginary line L, it is possible to maintain the wavelengths of the generated standing waves approximately constant along the imaginary line L.

Furthermore, the rear space H may be substantially sealed except for a small gap caused during the assembling process.

A sound absorber is constituted by material operable to attenuate the standing waves generated in the rear space H, and the rear space H may be filled with the sound absorber.

This means that each speaker unit 100 of the array speaker system 10 may have the sound absorber, which the rear space H is to be filled with.

The sound absorber may be made by a plurality of sound absorbents disposed adjacent to one another in a multilayered manner, wherein the plurality of sound absorbents are different from one another in sound absorption property.

In this case, it is preferable that boundary lines of a plurality of sound absorbents disposed in a multilayered manner are parallel with respect to the sound emission surface. Especially, it is preferable to employ such multilayered sound absorbents if a shape of the front surface of the rear space H (installation surface of the speaker) is not parallel with respect to the imaginary line L (for example, in a case in which the actuator or the like having a complex shape is installed on the rear side posterior to the sound emission surface).

The sound absorbent may be made of material which can effectively absorb standing waves generated in the rear space H, and may include, for example, glass wool, a resin plate, or the like.

Although, it has been described as an example that the outer casing 200 shown in FIG. 2 is constituted by a structure to accommodate and support the plurality of speaker units 100 arrayed in one line, the present disclosure is not limited thereto. For example, similar effects can be expected even if the outer casing is constituted by a structure that accommodates and supports a plurality of speaker units 100 arrayed in a plurality of lines arranged one line after another, along the imaginary line L.

The following description is directed to an array speaker system 10 according to a third embodiment of the present invention with reference to drawings.

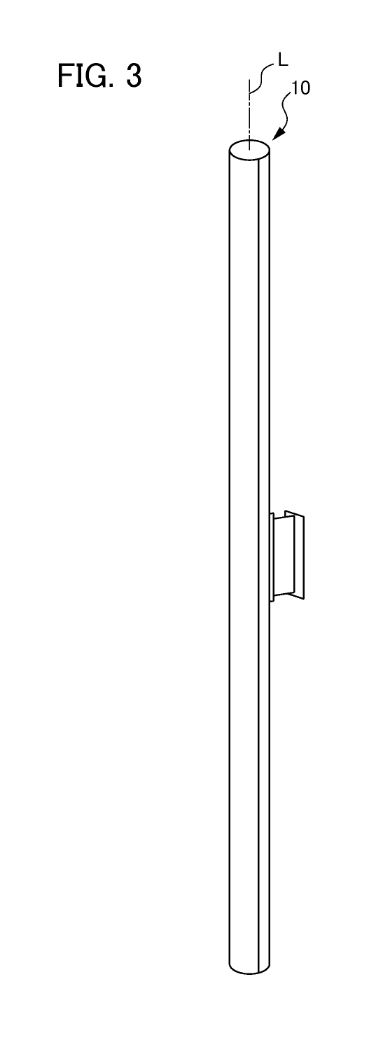

FIG. 3 is a perspective view of the array speaker system 10 according to the third embodiment of the present invention. Though not illustrated, inside the array speaker system 10, a plurality of speaker units 100 are arranged along an imaginary line L.

Similar to the embodiments described above, the array speaker system 10 includes a plurality of speaker units 100 and an outer casing 200 (see FIGS. 1 and 2). Similar constituent elements are denoted by the same symbols, and detailed description thereof is omitted.

The speaker unit 100 is constituted by an acoustic device that emits a sound in accordance with a signal inputted to the speaker unit 100.

The outer casing 200 is constituted by a structure that supports the plurality of speaker units 100 arrayed in one line.

Each speaker unit 100 constituting the array speaker system 10 includes a speaker 110 and a cavity back box 120.

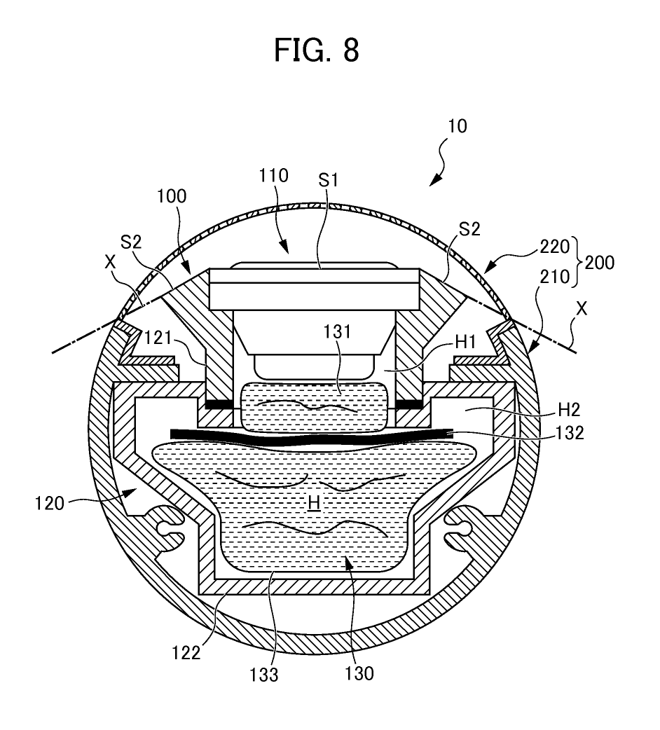

Each speaker unit 100 may include the speaker 110, the cavity back box 120, and a sound absorber 130 (see FIG. 8).

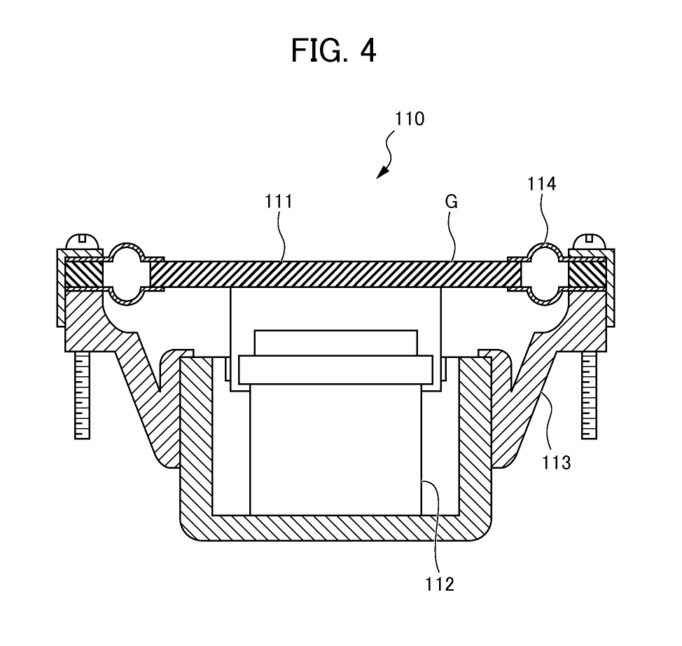

Here, a description is given of an example of structure of the speaker 110 according to the present embodiment with reference to FIGS. 4 to 6.

As shown in FIG. 4, the speaker 110 according to the present embodiment includes a vibrator 111 and an actuator 112. The speaker 110 may include a plurality of actuators 112.

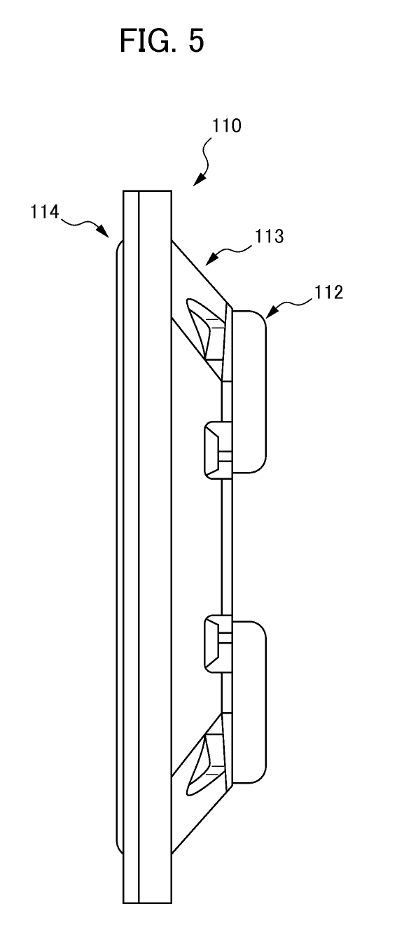

As an example, in the present embodiment, the speaker 110 includes a vibrator 111 and two actuators 112, as shown in FIG. 5.

Referring back to FIG. 4, the speaker 110 includes an actuator frame 113. Furthermore, the speaker 110 includes an edge 114 in addition to the vibrator 111, the actuator 112, and the actuator frame 113.

The speaker 110 is constituted by, for example, a flat speaker.

As shown in FIG. 4, the vibrator 111 is provided with a sound emission surface G that emits sounds on a front surface thereof. For example, the vibrator 111 may have a predetermined thickness. The surface of this plate constitutes a sound emission surface G.

The vibrator 111 is provided with the sound emission surface G in the form of a flat shape extending along a plane parallel to the imaginary line L, which has been described in the previous embodiments.

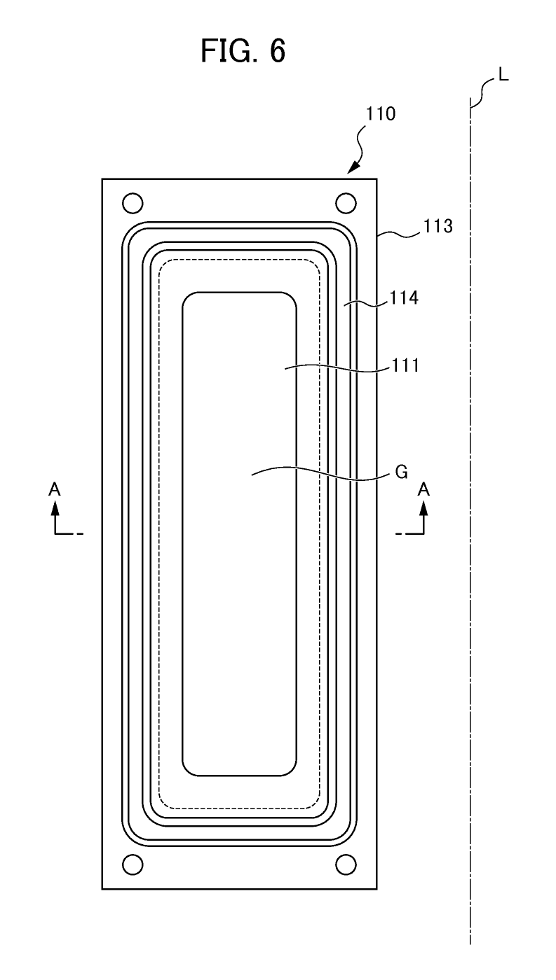

As shown in FIG. 6, the vibrator 111 is provided with the sound emission surface G formed with a contour including a pair of parallel long sides and a pair of parallel short sides. The contour of the sound emission surface G is indicated by a dashed line in FIG. 6.

For example, the sound emission surface G may be formed with a contour including a pair of parallel long sides, a pair of parallel short sides, and four curves, each of which connects adjacent edges of the long and short sides.

For example, the sound emission surface G may be formed with a contour of an approximately rectangular shape rounded at four corners. The vibrator 111 may be constituted by a planar diaphragm.

An edge piece 114 of the vibrator 111 can be made of flexible material.

The actuator frame 113 supports an edge of the vibrator 111 via the edge piece 114. As a result thereof, the vibrator 111 can vibrate in a direction perpendicular to the sound emission surface G to emit a sound in a flat manner.

The long sides of the contour of the sound emission surface G of each speaker unit 100 may be parallel to the imaginary line L.

The actuator 112 drives the vibrator 111 in accordance with a signal inputted to the speaker unit 100.

The actuator 112 may be constituted by, for example, a voice coil type actuator.

The sound emission surfaces G of the vibrators 111 may face toward the same direction.

As shown in FIG. 7, the cavity back box 120 supports the speaker 110 and forms a rear space H enclosed by the speaker 110 and the cavity back box 120 on the rear side of the vibrator 111, which is opposite to the side provided with the sound emission surface G.

The cavity back boxes 120 constituting the array speaker system 10 may be identical in shape and size to one another.

The cavity back box 120 includes a first cavity back box 121 that supports the speaker 110, and a second cavity back box 122 that supports the first cavity back box 121, and a packing 115.

The first cavity back box 121 forms a first rear space H1 together with the speaker 110.

The second cavity back box 122 forms a second rear space H2 together with the first cavity back box 121.

This means that the rear space H includes the first rear space H1 held in contact with the rear side of the vibrator 111 and the second rear space H2 held in communication with the first rear space H1. The second rear space H2 may be formed in such a manner that the cross section area of the second rear space H2 cut along any plane perpendicular to the imaginary line L is constant along the imaginary line L.

In this case, the first rear space H1 may be smaller in space volume than the second rear space H2, as shown in FIG. 7. This means that, if the front surface of the speaker 110 is viewed from a direction perpendicular to the imaginary line L, the width dimension of the first rear space H1 may be less than the width dimension of the second rear space H2. Also, if the front surface of the speaker 110 is viewed from the direction perpendicular to the imaginary line L, the cross section area of first rear space H1 cut along a plane perpendicular to the line of sight may be less than the cross section area of first rear space H1 cut along a plane perpendicular to the line of sight.

The packing 115 is adapted to seal the boundary between the first cavity back box 121 and the second cavity back box 122.

As described above, standing waves are generated on the basis of various factors such as a distance between top and bottom surfaces of the rear space, a distance between left and right surfaces of the rear space, and a distance between front and rear surfaces of the rear space. Meanwhile, if the rear space is not in the form of a geometrically simple shape such as a rectangular shape or a square shape, factors which cause the standing waves to occur in the rear space become more complicated. However, from among standing waves generated in the rear space, standing waves of the longest wavelength are determined by the dimensions of the rear space, and standing waves of high frequencies can be more easily attenuated by using, for example, a sound absorber, in comparison with standing waves of low frequencies.

In a case, as shown in FIG. 7, in which the shape of the front surface of the rear space H (installation surface of the speaker) is not parallel to the imaginary line L, standing waves generated in the rear space H may be complex. In such a case, the rear space can be made such that the rear space H is partitioned into a first rear space H1 having the front surface and a second rear space, and the first rear space H1 is made smaller than the second rear space H. In this manner, the frequencies of the standing waves generated in the first rear space H1 can be made high. As described above, it is possible to attenuate high frequency standing waves in an easier manner. It is possible to attenuate the complex standing waves likely generated in the first rear space H1 using, for example, a plurality of sound absorbents disposed adjacent to one another in a multilayered manner, as described earlier.

Furthermore, in a case in which the first rear space H1 is made small, it is possible to prevent standing waves of low frequencies (long wavelengths) from being generated in a space on the side of the speaker, thereby making it possible for the low frequency standing waves to exert influences on the speaker.

On the other hand, since the second rear space H2 is made larger than the first rear space H1, standing waves of lower frequencies can be generated in the second rear space H2 than in the first rear space H1. However, the second rear space H2 is made such that the cross section area of the second rear space H2 cut along any plane perpendicular to the imaginary line L is always constant along the imaginary line L. This means that the second rear space H2 has a geometrically simple shape such as a rectangular shape or a square shape. Accordingly, it is possible to attenuate standing waves generated in the second rear space H2 in a relatively easy manner, as well. For example, it is possible to attenuate the complex standing waves likely generated in the second rear space H2 using, for example, a single sound absorbent (single-layered sound absorbent), although a plurality of sound absorbents disposed adjacent to one another in a multilayered manner are used for the first rear space H1.

In the present embodiment, the first rear space H1 is disposed on the side of the speaker and the second rear space H2 is disposed posterior to the first rear space H1. As a result thereof, it is possible to reduce the wavelengths (increase the frequencies) of the standing waves generated on the side of the speaker, in comparison to a case, in which only one rear space is provided. Furthermore, in the present embodiment, the first rear space H1 is smaller in volume than the second rear space H2. As a result thereof, it is possible to prevent standing waves of low frequencies (long wavelengths) from being generated in a space on the side of the speaker, thereby preventing low frequency standing waves from exerting adverse influences on the speaker. The standing waves generated in the first rear space H1 can be easily attenuated by filling the first rear space H1 with a plurality of sound absorbents disposed in a multilayered manner.

Furthermore, standing waves of long wavelengths generated in the second rear space H2 cannot exist in a smaller space like the first rear space H1. Accordingly, it is difficult for the standing waves of long wavelengths generated in the second rear space H2 to propagate into the first rear space H1 disposed anterior to the second rear space H2. As a result thereof, it is possible to prevent the standing waves in the second rear space H2, which is lager in volume, to exert adverse influences. Furthermore, since the second rear space H2 is made such that the cross section area of the second rear space H2 cut along any plane perpendicular to the imaginary line L is always constant along the imaginary line L. This means that the second rear space H2 has a structure of a geometrically simple shape. Accordingly, it is possible to attenuate standing waves generated in the second rear space H2 in a relatively easy manner.

Furthermore, for the packing 115 which partitions between the first cavity back box 121 and the second cavity back box 122, material such as a rubber membrane, which is different in acoustic transmissivity from the cavity back box and capable of absorbing the vibration, is employed. Accordingly, it is possible to prevent resonance likely to be caused by mutual interference between sounds respectively generated from the first rear space H1 and the second rear space H2.

As shown in FIG. 8, a front side edge of each speaker unit 100 constituting the array speaker system 10 is formed with a planar portion S1 that approximately coincides with the sound emission surface G of the vibrator 111 and a pair of slant portions S2 that is slanted toward the rear side from both edges of the planar portion S1.

This means that the front side of the speaker unit 100 is formed with the planar portion S1 and the pair of slant portions S2 respectively provided from the both edges of the planar portion S1.

Similarly to the embodiments described above, the outer casing 200 may support the plurality of speaker units 100 arrayed in one line at the same intervals of pitch P.

The outer casing 200 may support the plurality of speaker units 100 so that the speaker units 100 are arrayed in one line along the imaginary line L, as described above.

The outer casing 200 may support the plurality of speaker units 100 so that the speaker units 100 are arrayed in one line at the same intervals of the pitch P along the imaginary line L.

The outer casing 200 may support the plurality of speaker units 100 so that the speaker units 100 are arrayed in a plurality of lines arranged one line after another along the imaginary line L. The imaginary line L may be straight and/or may be curved.

A cross section area of the rear space H cut along any imaginary plane perpendicular to the imaginary line L may be always constant along the imaginary line L, viewed at the regular intervals of the pitch P.

Furthermore, a contour cross section of the rear space H cut along any imaginary plane perpendicular to the imaginary line L may be always constant in shape and size along the imaginary line L, viewed at the regular intervals of the pitch P.

The rear space H may be substantially sealed except for a small gap caused during the assembling process.

As described above, each speaker unit 100 constituting the array speaker system 10 may include a sound absorber 130.

Here, a description is given of an example of arrangement of the sound absorber 130 with reference to FIG. 8.

In the example of FIG. 8, the sound absorber 130 includes a wool-like sound absorbent 131, a resin plate-like sound absorbent 132, and a wool-like sound absorbent 133, which are respectively disposed one after another in a multilayered manner, parallel to the sound emission surface G.

The sound absorber 130 is operable to attenuate standing waves generated in the rear space H. The rear space H is filled with the sound absorber 130. The sound absorber 130 is made by a plurality of sound absorbents disposed adjacent to one another in a multilayered manner, wherein the plurality of sound absorbents are different from one another in sound absorption property.

The sound absorber 130 is arranged such that layered boundary lines between the sound absorbents are parallel with respect to the sound emission surface.

The sound absorbents may be made of material which can effectively absorb standing waves generated in the rear space H, and may include, for example, glass wool, a resin plate, or the like.

The outer casing 200 is a structure which accommodates and supports the plurality of speaker units 100 arrayed in one line.

As shown in FIG. 8, in the present embodiment, the outer casing 200 includes an outer casing main body 210 and an outer casing cover 220.

Viewed from the above, i.e., a direction along the imaginary line L, the outer casing 200 has a contour of an approximately circular shape.

A front side part of the outer casing main body 210 is partially cut away along a pair of imaginary planes X that are imaginarily extended slant surfaces of the pair of slant portions S2.

The outer casing cover 220 covers the cutout portion of the outer casing main body 210. The outer casing cover 220 is formed with a large number of holes operable to have sound waves emitted from the sound emission surface G pass therethrough.

In general, there may be a case in which a speaker generates a weak sound wave in an unintended direction different from the intended direction due to interference among emitted sounds. This sound wave emitted in the unintended direction is called “side lobe”. The side lobe extends outwardly in a direction angled at a predetermined angle with respect to the intended direction. Accordingly, the side lobe emitted from the diaphragm is reflected by the outer casing, thereby causing interference between the speaker unit and the outer casing, and generating unexpected noises.

According to the present embodiment, as shown in FIG. 8, the front side part of the outer casing main body 210 is partially cut away along the pair of imaginary planes X, and the outer casing cover 220 covers the cutout portion of the outer casing main body 210. As a result thereof, it is possible to prevent sound waves emitted from the sound emission surface G from being reflected and interfered between the speaker unit 100 and the outer casing 200. Furthermore, the outer casing cover 220 is formed with a large number of holes operable to have sound waves emitted from the sound emission surface G pass therethrough. As a result thereof, it is less likely for the sound emitted from the sound emission surface G to be reflected between the speaker unit 100 and the outer casing 200. Accordingly, it is possible to prevent the sound emitted from the sound emission surface G from causing an unexpected side lobe to occur in a directivity pattern thereof.

The following description is directed to an array speaker system 10 according to a fourth embodiment of the present invention with reference to drawings.

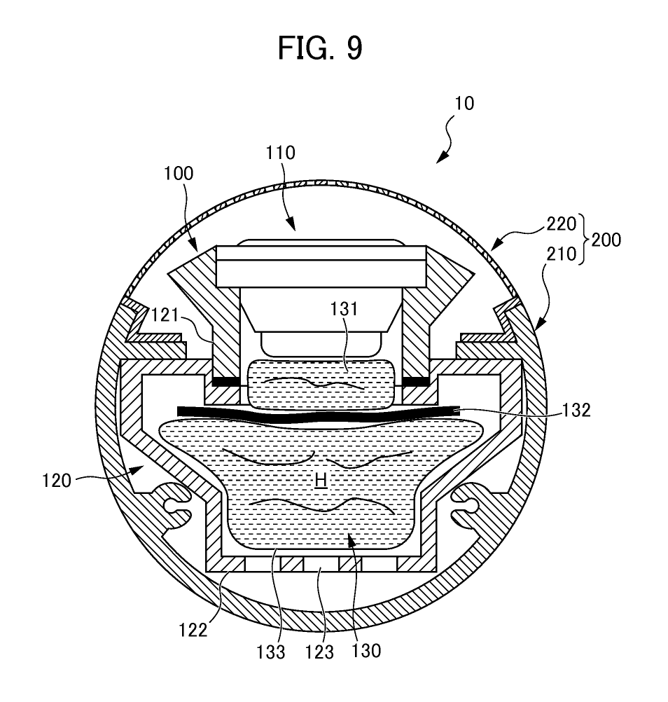

FIG. 9 is a plane cross section view of the array speaker system 10 according to the fourth embodiment of the present invention.

Since principal constituent elements of the array speaker system 10 according to the fourth embodiment are the same as those of the array speaker system 10 according to the third embodiment, the same constituent element will not be described, but only the constituent elements different from those of the array speaker system 10 according to the third embodiment will be described hereinafter. Constituent elements corresponding to the array speaker system 10 according to the first to third embodiments of the present invention are denoted by the same symbols, and description thereof is omitted.

The rear space H is held in communication with the space formed by the outer casing 200.

For example, the second rear space H2 is held in communication with the space formed by the outer casing 200.

For example, the second cavity back box 122 is formed with through holes 123 held in communication with a space formed by the outer casing 200. Owing to the through holes 123, it is possible to prevent sound waves from being reflected in the second cavity back box 122, thereby suppressing the occurrence of standing waves. Furthermore, owing to the through holes 123, it is possible to reduce the weight of the second cavity back box 122.

The following description is directed to an array speaker system 10 according to a fifth embodiment of the present invention with reference to drawings.

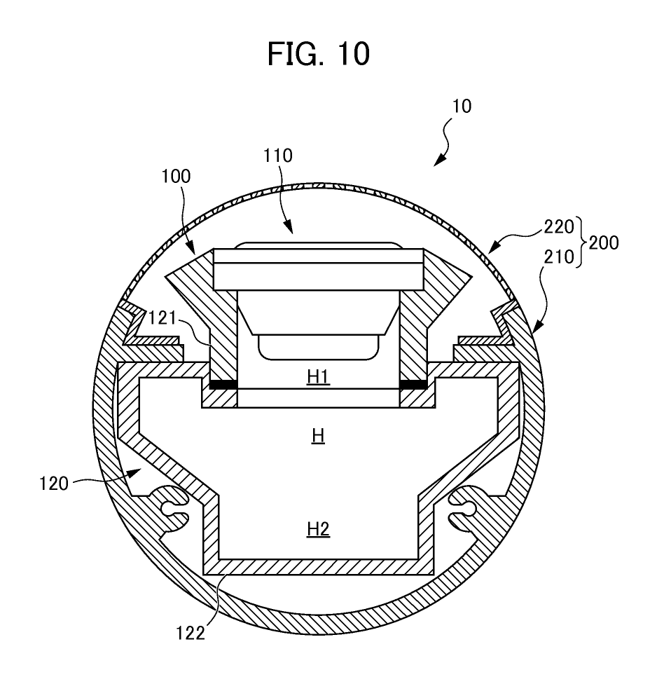

FIG. 10 is a plane cross section view of the array speaker system 10 according to the fifth embodiment of the present invention.

Since, principal constituent elements of the array speaker system 10 according to the fifth embodiment are the same as the array speaker system 10 according to the third embodiment, the same constituent element will not be described, but only the constituent elements different from those of the array speaker system 10 according to the third embodiment will be described hereinafter. Constituent elements corresponding to the array speaker system 10 according to the first to third embodiments of the present invention are denoted by the same symbols, and description thereof is omitted.

In the embodiments described above, the sound absorber is employed to absorb the standing wave generated in the rear space H and to prevent the standing waves from being emitted from the speaker. In the present embodiment, a reinforcer forms the rear space H, so that the rear space H, especially, the vibrator 111, is reinforced.

A reinforcer high in rigidity is high in resonance frequency, thereby less likely to transmit influences caused by low frequency standing waves, in comparison with a rear space H formed by a member low in rigidity. Accordingly, since the vibrator 111 is reinforced by using a reinforcer high in rigidity, it is possible to prevent standing waves generated in the rear space H from passing through the vibrator 111 and being outwardly emitted from the speaker.

Accordingly, the present embodiment is different from the fourth embodiment in that the vibrator 111 is reinforced and the rear space H is not filled with a sound absorber. The vibrator 111 may be made thick, or may be made of a material highly sensitive, highly rigid, and lightweight. According to such configuration, the sound absorber becomes not required, and it is possible to reduce the number of parts.

In the following, a description will be given of effects of the array speaker system 10 according to the above described first to fifth embodiments of the present invention with reference to drawings.

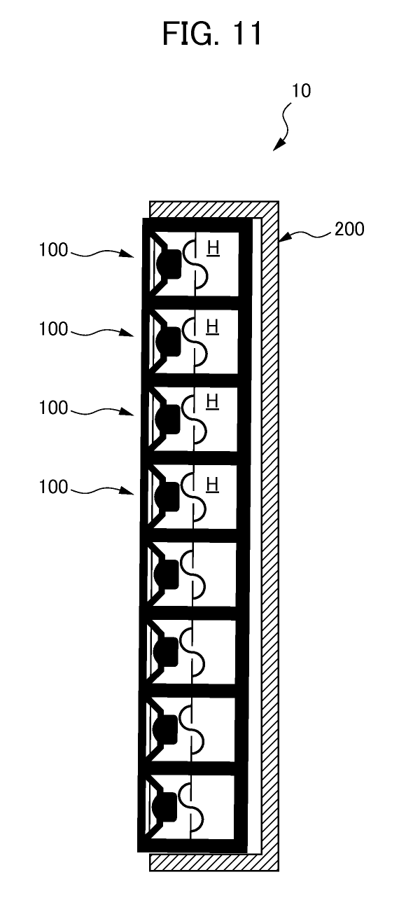

FIG. 11 is a diagram illustrating the effect of the array speaker system 10 according to the first to fifth embodiments of the present invention. FIG. 11 shows standing waves being respectively generated in the rear spaces H when signals are respectively input into the plurality of speaker units 100 to emit sounds. If the rear space H increases in space, generated standing waves increase in wavelength and decrease in frequency. On the other hand, if the rear space H decreases in space, generated standing waves decrease in wavelength and increase in frequency.

Thus, the acoustic properties of the standing waves depend on the shape and size of the rear space H.

In some embodiments, since the rear space H of each speaker unit 100 constituting the array speaker system 10 is designed to be small, it is possible to make the frequencies of the generated standing waves high.

It is easier to attenuate high frequency sounds than low frequency sounds. For example, it is possible to attenuate the standing wave generated in each rear space H using sound absorber or the like.

Furthermore, since the array speaker system 10 is constituted by the speaker units 100 arrayed one after another, wherein the speaker units 100 respectively having the rear spaces H, which are identical in shape and dimension to one another, it is possible to make the standing waves respectively generated in the rear spaces H identical in acoustic properties to one another.

As a result thereof, it is possible for the standing waves respectively generated by the speaker units 100 to exert acoustic identical influences in the array speaker system 10.

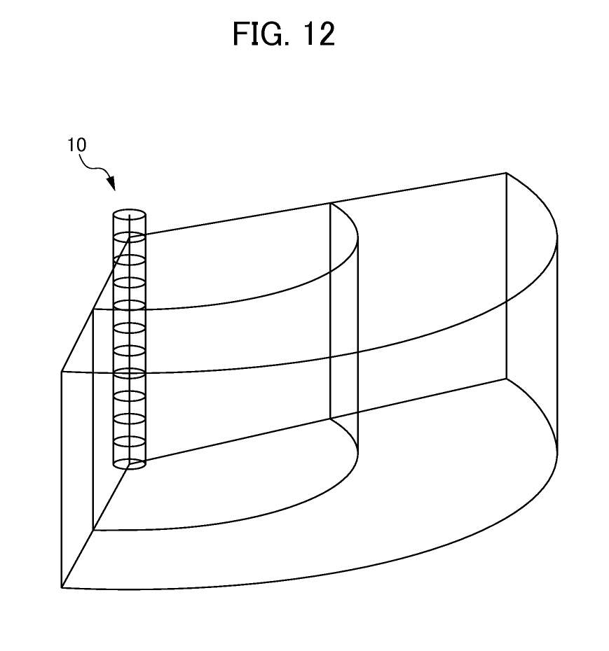

FIG. 12 is a diagram illustrating an acoustic property of the array speaker system 10 according to the first to fifth embodiments of the present invention. FIG. 12 shows a directivity pattern of the array speaker system 10 including a plurality of speaker units 100 arrayed in one line. It is evident that the directivity pattern is in the form of a planar fan shape extending along the imaginary line L. This means that the array speaker system 10 has a directivity pattern in the form of a planar fan shape represented in a sound pressure level distribution curve.

In the array speaker system 10 according to some embodiments, since it is easy to attenuate the standing waves generated in the rear spaces H of the respective speaker units 100, the directivity pattern of the array speaker system 10, formed as the acoustic property of the synthetic sound of the sounds respectively emitted from the speaker units arrayed in one line, has little disturbance and maintains a smooth shape.

Furthermore, since the standing waves generated in the speaker units 100 exert identical acoustic influence on the respective speaker units 100, the directivity pattern of the array speaker system 10, formed as the acoustic property of the synthetic sound of the sounds respectively emitted from the speaker units arrayed in one line, has little disturbance and maintains a smooth shape.

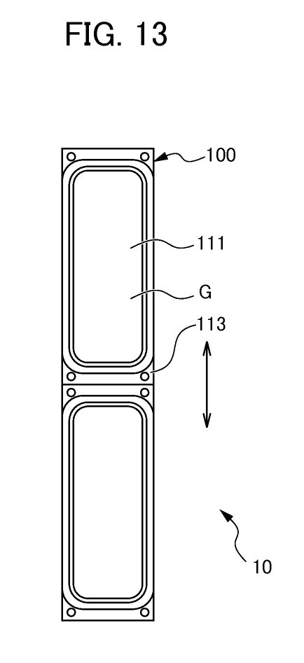

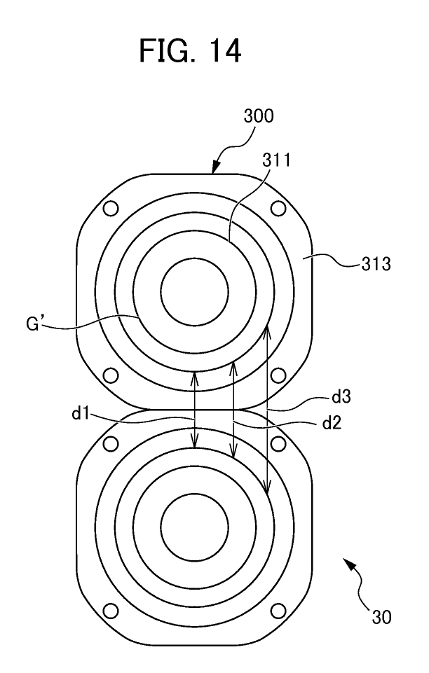

FIG. 13 is a front view of the array speaker system 10 according to the second to fifth embodiments of the present invention, in which a flat speaker is employed as the speaker 110. The array speaker system 10 includes a plurality of speaker units 100, each including the vibrator 111 and the actuator frame 113. Unlike the prior art array speaker system 30 described in FIG. 14, a flat speaker having an approximately rectangular vibrator 111 is employed as the speaker 110. Accordingly, the sound emission surface G formed by the vibrator 111 is approximately rectangular. As a result thereof, the distance between adjacent sound emission surfaces G maintains approximately the same. Furthermore, it is easy to reduce the distance. Accordingly, it is possible to minimize the influence of interferences between the adjacent sound emission surfaces G.

As described above, the array speaker system 10 according to some embodiments of the present invention can have following effects.

The outer casing 200 supports the plurality of speaker units 100 arrayed in one line. Each speaker unit 100 includes the speaker 110 and the cavity back box 120. The cavity back box 120 forms the rear space H enclosed on the rear side of the vibrator 111 that is driven by the actuator 112, in each speaker unit 100. Therefore, the size of the rear space H is limited to dimensions in accordance with the size of the speaker unit 100. As a result, it is possible to make the frequencies of the generated standing waves relatively high, thereby enabling to attenuate the standing waves in an easy manner. Furthermore, standing waves generated in the rear space H of one of the speaker units 100 arrayed in one line will not exert unexpected influences upon the other remaining speaker units 100 arrayed in the one line.

Furthermore, since the cavity back boxes 120 are identical in shape and size to one another, it is possible to make standing waves generated in the rear spaces H of respective speaker units 100 similar to one another in vibration properties. As a result thereof, it is possible to make speaker units 100 similar to one another in acoustic properties.

Since the speaker units 100 are arrayed in one line at the same intervals of the pitch P, it is possible to make the disturbance in the acoustic property of the synthetic sound of the sounds respectively emitted from the speaker units 100, as a whole, uniform with respect to the direction in which the speaker units are arrayed.

Furthermore, since the plurality of speaker units 100 are arrayed in one line along an imaginary line L, and cross section areas (or cross section area of a part) of the rear spaces H cut along any imaginary plane perpendicular to the imaginary line L are always constant along the imaginary line L, it is possible to stabilize the properties of the standing waves generated in the rear spaces H.

Furthermore, since the contour, shape and size of the cross section of the rear space H (or cross section of a part of the rear space H) cut along any imaginary plane perpendicular to the imaginary line L is always constant along the imaginary line L, it is possible to stabilize the properties of the standing waves generated in the rear spaces H.

Furthermore, since the rear space H is substantially sealed except for a small gap caused during the assembling process. Accordingly, the standing waves generated in the rear space H can hardly be affected from any space exterior to the rear space H. As a result thereof, it is possible to stabilize the standing waves.

Furthermore, since each of the speaker units 100 has the rear space H filled with a sound absorber, it is possible to attenuate the standing wave generated in the rear space H.

Furthermore, since the rear space of each of the speaker units 100 is filled with a sound absorber, and the sound absorber includes a plurality of sound absorbents disposed adjacent to one another in a multilayered manner, wherein the plurality of sound absorbents are different from one another in sound absorption property. Accordingly, it is possible to attenuate the standing waves generated in the rear space H in a more stable manner.

Furthermore, since the plurality of speaker units 100 constituting the array speaker system 10 are arrayed in one line along the imaginary line L, and the sound emission surface G has a flat shape extending along a plane parallel to the imaginary line L, the standing waves generated in the rear space H are stably attenuated and exert little influences on the sound emission surface.

Furthermore, since the plurality of speaker units 100 constituting the array speaker system 10 are arrayed in one line along the imaginary line L, the sound emission surface G has a flat shape extending along a plane parallel to the imaginary line L, and boundary lines of a plurality of sound absorbents are disposed in a multilayered manner, respectively parallel with respect to the sound emission surface G, the standing waves generated in the rear space H are stably attenuated and exert little influences on the sound emission surface.

Furthermore, since the plurality of speaker units 100 are arrayed in one line along the imaginary line L, and the sound emission surface G is formed with a contour of an approximately rectangular shape rounded at four corners, having a pair of long sides extending in parallel relationship to each other with respect to the imaginary line L, it is possible to reduce disturbance in the acoustic property of the synthetic sound of the sounds respectively emitted from the speaker units 100, as a whole, uniform with respect to the direction in which the speaker units are arrayed.

Furthermore, since the first cavity back box 121 forms a first rear space H1 and the second cavity back box 122 forms a second rear space H2, wherein the first rear space H1 is made smaller in space volume than the second rear space H2, it is possible to reduce the influences of the standing waves generated in the second rear space H2 on the vibrator via the first rear space H1.

Furthermore, since the first cavity back box 121 forms a first rear space H1 and the second cavity back box 122 forms a second rear space H2, wherein, viewed from a direction perpendicular to the imaginary line L, the width dimension of the first rear space H1 is less than the width dimension of the second rear space H2, it is possible to reduce the influences of the standing waves generated in the second rear space H2 on the vibrator via the first rear space H1.

Furthermore, since each speaker unit is partly formed with a cutout portion in front of the sound emission surface, owing to the cutout portion disposed in front of the sound emission surface, sound waves emitted from the sound emission surface G are emitted toward the front side of the speaker unit without being disturbed by the cavity back box 120, thereby making it possible to realize a directivity having little disturbance.

It should be noted that the present disclosure is not limited to the embodiments described above, and any modifications and improvements thereto within the scope that can realize one or more of the objects of the present disclosure are included in the scope of the disclosure.

In the embodiments described above, it has been described that the plurality of speaker units 100 are arrayed in one line. However, the present disclosure is not limited thereto. For example, the plurality of speaker units 100 may be arrayed in a plurality of lines arranged one line after another.

Furthermore, the plurality of speaker units 100 may be arrayed in one or more straight lines, and the plurality of speaker units 100 may be arrayed in one or more curved lines.

Furthermore, a description has been given in the third embodiment in which the long and short sides of the contour of the sound emission surface G are straight. However, the present disclosure is not limited thereto. The long and short sides may be flexed. For example, the long and short sides may be curved.

While certain embodiments have been described, these embodiments have been presented by way of example only, and are not intended to limit the scope of the protection. Indeed, the novel methods and systems described herein may be embodied in a variety of other forms. Furthermore, various omissions, substitutions and changes in the form of the methods and systems described herein may be made without departing from the spirit of the protection. The accompanying claims and their equivalents are intended to cover such forms or modifications as would fall within the scope and spirit of the protection. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. An array speaker system, comprising:
a plurality of speaker units that respectively emit sounds in accordance with a signal inputted therein; and
an outer casing that supports the plurality of speaker units, wherein each of the speaker units includes:
a speaker operable to vibrate a vibrator in accordance with the signal; and
a cavity back box that supports the speaker, wherein the cavity back box forms a rear space with the vibrator on the opposite side with respect to a sound emission surface.

2. The array speaker system as set forth in claim 1, wherein
the cavity back boxes of the respective speaker units are identical in shape and size to one another.

3. The array speaker system as set forth in claim 1, wherein
the outer casing supports the plurality of speaker units arrayed equidistantly in one line.

4. The array speaker system as set forth in claim 1, wherein
the rear space has a partial space, wherein a cross section area of the partial space cut along a plane perpendicular to a direction, in which the plurality of speaker units are arrayed, is constant along a direction, in which the plurality of speaker units are arrayed.

5. The array speaker system as set forth in claim 4, wherein
a remaining space, which is a part of the rear space other than the partial space, is smaller in cross section area cut along a plane perpendicular to a direction, in which the plurality of speaker units are arrayed, than the partial space.

6. The array speaker system as set forth in claim 4, wherein
a remaining space, which is a part of the rear space other than the partial space, is held in communication with the partial space.

7. The array speaker system as set forth in claim 1, wherein
the sound emission surface of the vibrator constituting each of the speaker units includes a contour having a pair of long sides extending in parallel relationship to each other with respect to the direction, in which the plurality of speaker units are arrayed, and a pair of short sides extending in parallel relation to each other.

8. The array speaker system as set forth in claim 1, wherein
each of the speaker units has the rear space filled with a sound absorber.

9. The array speaker system as set forth in claim 1, wherein
the sound emission surface is in the form of a flat shape extending along a plane parallel to the direction, in which the plurality of speaker units are arrayed.

10. The array speaker system as set forth in claim 1, wherein
the rear space is substantially sealed.

11. The array speaker system as set forth in claim 1, wherein
each of the speaker units has the rear space filled with a sound absorber, wherein
the sound absorber includes a plurality of sound absorbents different from one another in sound absorption property.

12. The array speaker system as set forth in claim 4, wherein
a remaining space, which is a part of the rear space other than the partial space, is filled with a plurality of sound absorbents different from one another in sound absorption property.

13. The array speaker system as set forth in claim 1, wherein
the speaker unit is formed with a cutout portion partially cut away in front of the sound emission surface.
